(19) United States
(12) Patent Application Publication
(10) Pub. No.: US 2026/0126588 A1
(43) Pub. Date: May 7, 2026

(54) POLARIZATION SPLITTER-ROTATOR

(71) Applicant: Lumentum Operations LLC, San Jose, CA (US)

(72) Inventors: Md Borhan MIA, San Jose, CA (US); Kenneth A. MCGREER, San Jose, CA (US); Erman TIMURDOGAN, Arlington, MA (US)

(21) Appl. No.: 18/989,699

(22) Filed: Dec. 20, 2024

Related U.S. Application Data
(60) Provisional application No. 63/717,659, filed on Nov. 7, 2024.

(51) Int. Cl. G02B 6/126; G02B 6/12; G02B 6/122; G02B 6/27

(52) U.S. Cl. CPC G02B 6/126; G02B 6/1228; G02B 6/2766; G02B 2006/12061; G02B 2006/1215

(57) ABSTRACT

A photonic integrated circuit (PIC) may include a polarization rotator. The polarization rotator may include a first waveguide layer comprising a first set of waveguides. At least one waveguide of the first set of waveguides may be a segmented waveguide. The polarization rotator may include a second waveguide layer comprising a second set of waveguides. A refractive index of a core material of the second set of waveguides may be less than a refractive index of a core material of the first set of waveguides.

### CROSS-REFERENCE TO RELATED APPLICATION

This patent application claims priority to U.S. Provisional Patent Application No. 63/717,659, filed on Nov. 7, 2024, and entitled “MULTI-CORE METAMATERIAL-ENHANCED ON-CHIP POLARIZATION SPLITTER-ROTATOR.” The disclosure of the prior application is considered part of and is incorporated by reference into this patent application.

### TECHNICAL FIELD

The present disclosure relates generally to a polarization splitter-rotator (PSR) and to a PSR comprising one or more segmented waveguides.

### BACKGROUND

A polarization splitter-rotator (PSR) is a passive photonic component that splits polarized light into two separate paths based on the polarization state of the polarized light. A PSR can operate with transverse electric (TE) or transverse magnetic (TM) polarized light. In operation of a PSR, one polarized light input is changed into its orthogonal polarization state at the output for one path, while the other polarized light input maintains its original state at the output for another path. For example, a PSR may convert TM-polarized light to TE polarization and retain TE-polarized light in its original state. This capability improves manipulation and management of light within photonic integrated circuits (PICs), which contributes to, for example, advancements in devices that require polarization insensitivity, efficiency of coherent optical transceivers, and on-chip optical communication systems.

### SUMMARY

In some implementations, a photonic integrated circuit (PIC) comprising a polarization rotator includes a first waveguide layer comprising a first set of waveguides, wherein at least one waveguide of the first set of waveguides is a segmented waveguide; and a second waveguide layer comprising a second set of waveguides, wherein a refractive index of a core material of the second set of waveguides is less than a refractive index of a core material of the first set of waveguides.

In some implementations, a PIC comprising a polarization splitter-rotator includes a polarization rotator including: a first set of waveguides in a first waveguide layer, wherein at least one waveguide of the first set of waveguides is a segmented waveguide, and a second set of waveguides in a second waveguide layer, wherein a refractive index of a core material of the second set of waveguides is less than a refractive index of a core material of the first set of waveguides; and a polarization splitter and a mode splitter, wherein the polarization splitter is optically connected to the mode splitter.

In some implementations, a PIC comprising a polarization rotator includes a silicon (Si) waveguide layer comprising a set of segmented Si waveguides, wherein a periodicity of a segmented Si waveguide in the set of segmented Si waveguides less than approximately 900 nanometers (nm), and wherein a filling fraction of the segmented Si waveguide is in a range from approximately 0.1 to approximately 0.8; and a silicon nitride (SiNₓ) waveguide layer comprising a set of SiNₓ waveguides,

### BRIEF DESCRIPTION OF THE DRAWINGS

FIG. 1 is a diagram illustrating an example implementation of a PSR including one or more segmented waveguides described herein.

FIG. 2 illustrates examples of calculated dielectric constants with respect to filling fraction for various wavelengths.

FIG. 3 is a diagram illustrating effective indices of the fundamental transverse electric (TE₀) mode, the fundamental transvers magnetic (TM₀) mode, and the first order TE (TE₁) mode for an example implementation of the PSR described herein with different spacer region heights.

FIGS. 4-7 are diagrams illustrating field profiles determined by the effective indices as shown in FIG. 3.

FIG. 8 illustrates eigenmode expansion for excitation of the TE₀ and TM₀ modes in an example implementation of the PSR described herein.

FIG. 9 shows an effect of a filling fraction on power confinement in waveguides of the PSR described herein as a spacer height is varied.

FIG. 10 shows an effect of a filling fraction on power confinement in waveguides of the PSR described herein for a particular spacer height with variation of another filling fraction.

FIG. 11 illustrates effective indices along a rotation section of the PSR described herein for different values of a width of a segmented waveguide.

FIG. 12 is a diagram illustrating a coupling factor associated with the PSR described herein while a spacing between waveguides of the PSR is varied.

FIG. 13 illustrates an example of effective indices of different modes supported by waveguides of the PSR described herein along a mode splitter of the PSR.

FIGS. 14-17 are diagrams illustrating field profiles determined by effective indices that demonstrate how modes are distributed along a splitting length of the PSR described herein.

FIG. 18 is a diagram illustrating an example associated with a mode conversion length of the PSR described herein.

FIG. 19 is a diagram illustrating an example associated with a coupling factor for different values of a filling fraction with respect to a mode splitter of the PSR described herein.

FIG. 20 illustrates effective indices of the fundamental and first-order modes throughout a length of the PSR described herein.

### DETAILED DESCRIPTION

The following detailed description of example implementations refers to the accompanying drawings. The same reference numbers in different drawings may identify the same or similar elements.

Silicon photonics is a promising platform for PSRs due to its high index of refraction, supporting higher-order TE modes (e.g., TE₁), and facilitating extensive hybridization and coupling between the TE₁ mode and the fundamental TM (TM₀) mode. This hybridization and coupling can be used to rotate the TM₀ mode to the TE₁ mode within a silicon (Si) waveguide. Of note, a waveguide made of a material with a comparatively lower refractive index, such as silicon nitride (SiNₓ), requires broader dimensions to achieve similar hybridization and coupling. This is because of the minimal birefringence between the TE₁ and TM₀ modes in SiNₓ waveguides. The weak birefringence means that a significant perturbation is required to increase the mode hybridization and coupling, leading to longer mode conversion lengths that may not be practical for some uses of PICs.

However, passive photonic components, such as PSRs, can benefit from using SiNₓ waveguides with silica (SiO₂) claddings. This is because SiNₓ provides improved performance as compared to conventional Si waveguides. For example, SiNₓ has significantly reduced optical nonlinearities and thermo-optic effects, which makes SiNₓ suitable in, for example, high-power applications. Moreover, SiNₓ waveguides have a lower index of refraction, which reduces waveguide losses due to scattering with sidewall roughness, meaning that SiNₓ waveguides are tolerant to variations in waveguide dimension. Therefore, SiNₓ PSRs may play a significant role in PICs.

Some techniques use hybrid SiNₓ—Si PSRs. Purely SiNₓ-based PSRs are not commonly used, likely due to the low birefringence and minimal perturbation effects of purely SiNₓ-based PSRs. Additionally, purely SiN-based PSRs are conventionally designed for relatively shorter wavelength range (e.g., from approximately 800 nm to approximately 1000 nm) due to the perturbation at lower wavelengths. However, perturbation is relatively small (e.g., Δn=0.00286), which calls for longer taper lengths, often in the millimeter range, making integration into compact devices a challenge.

To design efficient PSRs for operation in different optical bands (e.g., the O band, the E band, the S band, the C band, or the L band), engineering of the hybridization (i.e., Δn) of the TE₁ and TM₀ modes is important. This engineering process may involve the use of a hybrid section comprising SiNₓ and Si. A hybrid PSR with a SiNₓ-to-Si transition segment has been used to facilitate mode rotation and splitting within Si waveguides before transitioning back to a SiNₓ layer. However, such an approach can introduce additional losses, particularly in the TM mode, due to the transition segment (e.g., SiNₓ-to-Si and Si-to-SiNₓ). Additionally, significant two-photon absorption (TPA) losses may occur in the Si waveguide due to a high nonlinearity of the Si waveguide at higher power levels. An alternative approach includes placing traditional Si waveguides beneath SiNₓ waveguides. This approach enhances perturbation between the TE₁ and TM₀ modes, which eases rotation of the mode within SiNₓ waveguides. However, this hybridization tends to be weak, meaning that a longer conversion length is required. Additionally, such a configuration can result in significant light leakage into the conventional Si waveguide, which causes nonlinear absorption and limits usability in high-power applications.

Some implementations described herein provide a PIC comprising a polarization rotator that includes one or more segmented waveguides. In some implementations, the polarization rotator includes a first waveguide layer (e.g., an Si waveguide layer) comprising a first set of waveguides (e.g., a set of Si waveguides), with at least one waveguide of the first set of waveguides being a segmented waveguide. The polarization rotator further includes a second waveguide layer (e.g., a SiNₓ waveguide layer) comprising a second set of waveguides (e.g., a set of SiNₓ waveguides). Here, a refractive index of a core material of the second set of waveguides may be less than a refractive index of a core material of the first set of waveguides.

In some implementations, one or more parameters of the segmented waveguides, such as filling fraction ρ or a periodicity Λ, may be selected so as to control the propagation of light along the segmented waveguides of the polarization rotator. In some implementations, the segmented waveguides introduce anisotropy and provide precise control of modes effective indices and reduce absorption loss when dealing with high power, while simultaneously enhancing mode hybridization and coupling (e.g., in SiNₓ segmented waveguides due to the introduced large hybridization from underlying Si segmented waveguides), thereby reducing conversion lengths and reducing overall optical loss.

Some implementations include segmented SiNₓ and Si metamaterials, which enables a high power PSR with low optical and absorption losses and reduced mode conversion length. In some implementations, segmented SiNₓ and Si segmented/metamaterials waveguides may be used to enhance coupling and hybridization between the TE₁ and TM₀ modes which, in effect, reduces a mode conversion length in both the rotation and splitting segments. Of note, the segmented waveguides described herein provide low nonlinearity, which reduces absorption loss in high-power scenarios. Moreover, most of the optical power may be confined within the SiNₓ waveguides, which further decreases nonlinearity and overall optical losses. Notably, although the implementations described herein are based on SiNₓ and Si periodic segmented structures or subwavelength gratings (SWGs), the techniques described herein are applicable to various material platforms with Si segmented waveguides with periodic and aperiodic structures, conventional SiNₓ (i.e., not segmented) waveguides, or SiNₓ segmented waveguides, and can accommodate different waveguide dimensions. Additional details are provided below.

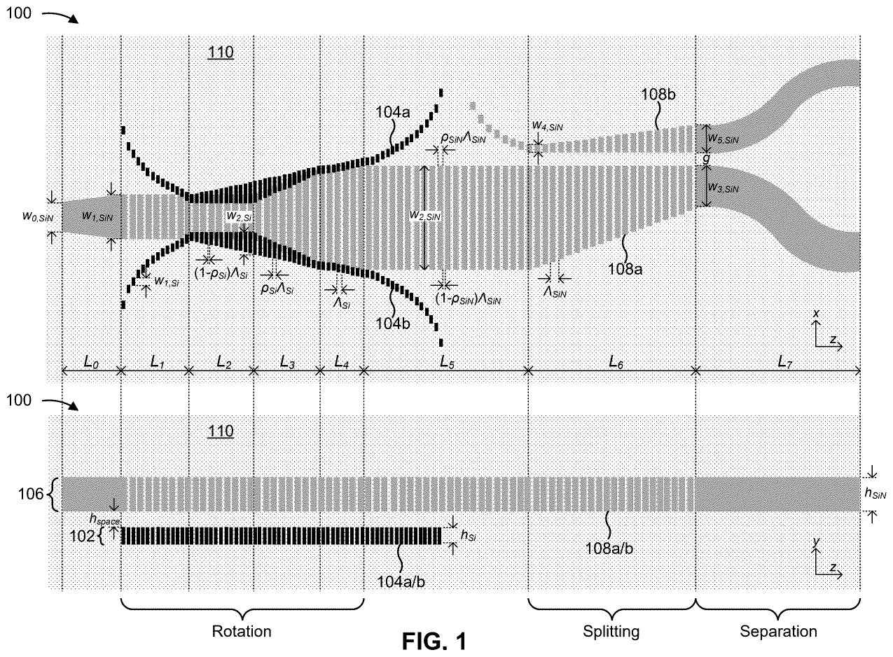

FIG. 1 is a diagram illustrating an example implementation of a PSR 100 including one or more segmented waveguides. In some implementations, the one or more segmented waveguides of the PSR 100 form an SWG structure or a metamaterial. The upper diagram in FIG. 1 illustrates a plan view of the PSR 100 (e.g., on an x-z plane), while the lower diagram in FIG. 1 illustrates a cross-sectional view of the PSR 100 (e.g., on a y-z plane). In some implementations, the PSR 100 may be implemented in a PIC. As shown in FIG. 1, the PSR 100 may comprise a first waveguide layer 102 including a first set of waveguides 104 (e.g., waveguide 104a and waveguide 104b), a second waveguide layer 106 including a second set of waveguides 108 (e.g., waveguide 108a and waveguide 108b), and a cladding 110. In some implementations, as illustrated in FIG. 1, at least one waveguide 104 is a segmented waveguide (e.g., both waveguides 104a and 104b are segmented waveguides in FIG. 1).

In some implementations, as illustrated in FIG. 1, the PSR 100 includes a polarization rotator. The polarization rotator may correspond to the “rotation” section of the PSR 100 as labeled in FIG. 1, and may be a section of the PSR 100 in which polarization or mode rotation of light is provided (e.g., as the light propagates from left to right through the PSR 100 along the z-direction). In some implementations, polarization rotator of the PSR 100 may comprise one or more segmented waveguide sections (e.g., a segmented waveguide 104a, a segmented waveguide 104b, a segmented section of the waveguide 108a along lengths L₁ through L₄). Additionally, or alternatively, the polarization rotator of the PSR 100 may comprise one or more tapered waveguide sections (e.g., tapered sections of the waveguides 104a and 104b along lengths L₂ through L₃, a tapered section of the waveguide 108a along the length L₃). Additionally, or alternatively, the polarization rotator of the PSR 100 may comprise a curved waveguide section with exponential tapering (e.g., sections of the waveguides 104a and 104b within the lengths L₁ and L₅).

As further shown, in some implementations, the PSR 100 further includes a mode splitter. The mode splitter may correspond to the “splitting” section of the PSR 100 as labeled in FIG. 1, and may be a section of the PSR 100 in which mode splitting is performed (e.g., as the light propagates from left to right through the PSR 100 along the z-direction). In some implementations, the mode splitter of the PSR 100 may comprise one or more segmented waveguide sections (e.g., a segmented section of the waveguide 108a and a segmented section of the waveguide 108b). Additionally, or alternatively, the mode splitter of the PSR 100 may comprise one or more tapered waveguide sections (e.g., a tapered section of the waveguide 108a and/or a tapered section of the waveguide 108b). Additionally, or alternatively, the mode splitter of the PSR 100 may comprise a curved waveguide section with exponential tapering (e.g., a section of the waveguide 108b within a length L₅). Here, the polarization rotator of the PSR 100 may be optically connected to the mode splitter. In some implementations, the mode splitter of the PSR 100 may be a directional coupler (e.g., two parallel SiNₓ segmented waveguides, but narrow band due to the phase matching length) or an adiabatic coupler (e.g., for broadband operation).

As further shown, in some implementations, the PSR 100 further includes a separator. The separator may correspond to the “separation” section of the PSR 100 as labeled in FIG. 1, and may be a section of the PSR 100 in which separation of the light is provided (e.g., as the light propagates from left to right through the PSR 100 along the z-direction). Here, the mode splitter of the PSR 100 may be optically connected to the separator. In some implementations, the separator of the PSR 100 may comprise one or more circular bends, Euler bends, or S-bends.

Additional details regarding the operation of the polarization rotator of the PSR 100, the mode splitter of the PSR 100, and the separator of the PSR 100 are provided below.

In some implementations, a refractive index of a core material of the second set of waveguides 108 is less than a refractive index of a core material of the first set of waveguides 104 (e.g., at a given wavelength). In one example, the first waveguide layer 102 may be an Si waveguide layer and the second waveguide layer 106 may be a SiNₓ waveguide layer, meaning that the core material of the first set of waveguides 104 is Si and the core material of the second set of waveguides 108 is SiNₓ. At a wavelength of 1550 nanometers (nm), a refractive index of Si is approximately 3.5 and a refractive index of SiNₓ (e.g., Si₃N₄) is approximately 2.0. Thus, the refractive index of the core material of the second set of waveguides 108 is less than the refractive index of the core material of the first set of waveguides 104 (e.g., 2.0<3.5).

In some implementations, the cladding 110 may comprise one or more of silica, an index matching fluid, or air. For example, a bottom portion of the cladding 110 (e.g., a portion of the cladding 110 up to surface of the second waveguide layer 106) may comprise silica, and a top portion of the cladding 110 (e.g., a portion of the cladding 110 above the second waveguide layer 106) may comprise an index matching fluid and/or air. In some implementations, the index matching fluid may be an adhesive designed to have a refractive index that is close to a refractive index of a material of another portion of the cladding 110 at a selected wavelength (e.g., to reduce reflection and scattering at an interface between the silica and the index matching fluid). In one example, the bottom portion of the cladding 110 may comprise silica, and the top portion of the cladding 110 may comprise an index matching fluid in the form of an epoxy that has a refractive index that is close to that of silica. Thus, in some implementations, the first set of waveguides 104 or the second set of waveguides 108 may be surrounded by one or more of silica, an index matching fluid, or air.

In some implementations, as noted above, the first set of waveguides 104 may comprise one or more segmented waveguides. That is, in some implementations, the first set of waveguides 104 may include one or more waveguides comprising segments of core material (e.g., Si), with a portion of the cladding 110 being between a given pair of adjacent waveguide segments of the waveguide 104. In such an implementation, the waveguide 104 may be segmented with respect to the x-direction such that the waveguide 104 has a periodicity in the x-direction and/or may be segmented with respect to the z-direction such that the waveguide 104 has a periodicity in the z-direction. For example, as shown in FIG. 1, the first set of waveguides 104 may include a waveguide 104a and a waveguide 104b, with the waveguide 104a and the waveguide 104b being segmented waveguides that have a periodicity Λ_{Si} in a z-direction. In some implementations, as illustrated in FIG. 1, a length of a given waveguide 104 (e.g., the waveguide 104a or the waveguide 104b) is with respect to the z-direction and a width of the given waveguide 104 is with respect to an x-direction. Here, the z-direction is parallel to a direction of propagation of light through the PSR 100 and the x-direction is perpendicular to the direction of propagation. In some implementations, as shown, a width of the waveguide 104 changes along the z-direction. For example, the waveguide 104 has a width w_{1,Si} throughout the length L₁. The width of the waveguide 104 then increases (e.g., linearly increases) from w_{1,Si} to w_{2,Si} over the length L₂, and decreases (e.g., linearly decreases) from w_{2,Si} to w_{1,Si} over the length L₃. The width of the waveguide 104 is w_{1,Si} throughout the length L₄ and a portion of the length L₅. In some implementations, the width w_{2,Si} of the waveguide 104 may be less than approximately 450 nm. In some implementations, the waveguide 104 has a height h_{Si}.

In some implementations, as shown in FIG. 1, one or more waveguide segments of a waveguide in the first set of waveguides 104 (e.g., each waveguide segment of waveguide 104a and each waveguide segment of waveguide 104b) may have a shape that is elongated with a longer dimension oriented at 90 degrees (°) with respect to a direction of propagation (e.g., the z-direction). Alternatively, one or more waveguide segments of a waveguide in the first set of waveguides 104 may in some implementations have a shape that is elongated with a longer dimension oriented at an arbitrary angle (e.g., an angle that is less than 90°) with respect to the direction of propagation. As examples, one or more waveguide segments in the waveguide 104a or the waveguide 104b may have a shape that is elongated with a longer dimension at an angle askew to 90°, such as an angle between approximately 70° and 90°, or an angle between approximately 50° and 90° (e.g., approximately 85°). Alternatively, one or more waveguide segments of a waveguide in the first set of waveguides 104 may in some implementations have a shape that is elongated with a longer dimension oriented nearly parallel (e.g., parallel to within a fabrication tolerance) with respect to the direction of propagation.

In some implementations, a given waveguide 104 of the first set of waveguides 104 may comprise one or more curved waveguide sections with exponential tapering. For example, in FIG. 1, the waveguide 104a and the waveguide 104b each comprises two curved waveguide sections with exponential tapering in the length L₁ or in the length L₅ (e.g., such that the first set of waveguides 104 comprises a four curved waveguide sections with exponential tapering). In some implementations, a curved section of a waveguide 104 (e.g., the waveguide 104a or the waveguide 104b) may facilitate smooth field transition with minimal loss. Further, in some implementations, the waveguides 104 may be arranged symmetrically with respect to a centerline of the waveguide 108a, as illustrated in FIG. 1. In some implementations, a spacing between the waveguide 104a and the waveguide 104b is in a range from approximately 0.3 micrometers (μm) to approximately 2.5 μm along a taper length associated with the waveguides 104a and 104b (e.g., along the length L₂).

In some implementations, the second set of waveguides 108 may comprise one or more at least partially segmented waveguides. That is, in some implementations, the second set of waveguides 108 may include one or more waveguides comprising segments of core material (e.g., SiNₓ), with a portion of the cladding 110 being between a given pair of adjacent waveguide segments of the waveguide 108. In such an implementation, the waveguide 108 may be segmented with respect to the z-direction such that the waveguide 108 has a periodicity in the x-direction and/or may be segmented with respect to the z-direction such that the waveguide 108 has a periodicity in the z-direction. For example, as shown in FIG. 1, the second set of waveguides 108 may include a waveguide 108a and a waveguide 108b. Here, the waveguide 108a is segmented from throughout length L₁ through length L₆ with a periodicity Λ_{SiN} in the z-direction. Similarly, waveguide 108b is segmented over a portion of the length L₅ and throughout the length L₆ with the periodicity Λ_{SiN} in the z-direction. In some implementations, as illustrated in FIG. 1, a length of a given waveguide 108 (e.g., the waveguide 108a or the waveguide 108b) is with respect to the z-direction and a width of the given waveguide 108 is with respect to the x-direction. In some implementations, as shown, a width of a waveguide 108 changes along the z-direction. For example, the waveguide 108a increases from w_{0,SiN} to w_{1,SiNM} over the length L₀ and has the width w_{1,SiN} throughout the length L₁ and the length L₂. The width of the waveguide 108a then increases from w_{1,SiN} to w_{2,SiN} over the length L₃, and has the width w_{2,SiN} throughout the length L₄ and the length L₅. The width of the waveguide 108a then decreases back from w_{2,SiN} to w_{3,SiN} over the length L₆, and has the width w_{3,Si} over the length L₇. Similarly, the width of the waveguide 108b is w_{4,SiN} over a portion of the length L₅, increases from w_{4,SiN} to w_{5,SiN} over the length L₆, and has the width w_{5,SiN} over the length L₇. In some implementations, a given waveguide 108 has a height h_{SiN}. In some implementations, a height h_{SiN} of a waveguide 108 may be different than (e.g., greater than) a height h_{Si} of a waveguide 104. Additionally, or alternatively, a height h_{SiN} of a waveguide 108 may match (e.g., be approximately equal to) a height h_{Si} of a waveguide 104.

In some implementations, as shown in FIG. 1, a segmented waveguide 104 may have a periodicity Λ_{Si} and a filling fraction ρ_{Si} (e.g., with respect to the z-direction in the case of segmentation along the z-direction). A width of a given segment of the waveguide 104 is a value equal to Λ_{Si}ρ_{Si}, and a width of a gap between a pair of adjacent segments of the waveguide 104 (e.g., a width of a portion of cladding 110 between the pair of adjacent segments of the waveguide 104) is a value equal to (1−ρ_{Si})Λ_{Si}. Of note, the waveguide 104 may in some implementations be segmented in with respect to the x-direction (e.g., perpendicular to the direction of propagation) in a similar fashion (e.g., with a same periodicity/filling fraction or with a different periodicity/filling fraction). In some implementations, the periodicity Λ_{Si} of a segmented waveguide 104 may be less than approximately λ/n, where λ is an operational wavelength of the PSR 110 and n is a refractive index of the segmented waveguide 104. In some implementations, by setting the periodicity Λ_{Si} to be smaller than λ, diffraction effects are reduced or minimized. Thus, in some implementations, a dimension (e.g., a width and/or a length) of a given segment of a waveguide 104 may be based on a wavelength range associated with the PSR 100. As a particular example, in some implementations, the periodicity Λ_{Si} of the segmented waveguide 104 may be less than approximately 400 nm (e.g., to enable use of the PSR 100 in the O band). As another example, the periodicity Λ_{Si} of the segmented waveguide 104 may be less than approximately 500 nm (e.g., to enable use of the PSR 100 in the C+L bands). In some implementations, the filling fraction ρ_{Si} associated with the segmented waveguide 104 in the first set of waveguides 104 may be in a range from approximately 0.1 to approximately 0.8.

Similarly, as shown in FIG. 1, a segmented waveguide 108 may have a periodicity Λ_{SiN} and a filling fraction ρ_{SiN} (e.g., with respect to the z-direction in the case of segmentation along the z-direction). A width of a given segment of the waveguide 108 is a value equal to Λ_{SiN}ρ_{SiN}, and a width of a gap between a pair of adjacent segments of the waveguide 108 (e.g., a width of a portion of cladding 110 between the pair of adjacent segments of the waveguide 108) is a value equal to (1−ρ_{SiN})Λ_{SiN}. Of note, the waveguide 108 may in some implementations be segmented in with respect to the x-direction (e.g., perpendicular to the direction of propagation) in a similar fashion (e.g., with a same periodicity/filling fraction or with a different periodicity/filling fraction). In some implementations, the periodicity Λ_{SiN} of a segmented waveguide 108 may be less than approximately λ/n, where λ is an operational wavelength of the PSR 110 and n is a refractive index of the segmented waveguide 108, as noted above. In some implementations, by setting the periodicity Λ_{SiN} to be smaller than λ, diffraction effects are reduced or minimized. Thus, in some implementations, a dimension (e.g., a width and/or a length) of a given segment of a waveguide 108 may be based on a wavelength range associated with the PSR 100. As a particular example, in some implementations, the periodicity Λ_{SiN} of the segmented waveguide 108 may be less than approximately 700 nm (e.g., to enable use of the PSR 100 in the O band). As another example, the periodicity Λ_{SiN} of the segmented waveguide 108 may be less than approximately 900 nm (e.g., to enable use of the PSR 100 in the C+L bands).

In some implementations, the PSR 100 includes a spacer region between the first waveguide layer 102 and the second waveguide layer 106. In the example shown in FIG. 1, the spacer region is region with a height h_{space} and comprises a portion of the cladding 110. Alternatively, the second waveguide layer 106 may in some implementations be on the first waveguide layer 102 (e.g., h_{space}=0 nm) or the first waveguide layer 102 may be on the second waveguide layer 106 (e.g., h_{space}=0 nm).

As indicated above, FIG. 1 is provided as an example. Other examples may differ from what is described with regard to FIG. 1. The number and arrangement of layers and elements shown in FIG. 1 are provided as an example. In practice, there may be additional elements and/or layers, fewer elements and/or layers, different elements and/or layers, or differently arranged elements and/or layers than those shown in FIG. 1. Furthermore, two or more elements and/or layers shown in FIG. 1 may be implemented within a single element, or a single element shown in FIG. 1 may be implemented as multiple, distributed elements and/or layers. Additionally, or alternatively, a set of elements and/or layers (e.g., one or more elements and/or layers) shown in FIG. 1 may perform one or more functions described as being performed by another set of elements and/or layers shown in FIG. 1. As a particular example, in some implementations, the PSR 100 may include a third waveguide layer (e.g., a waveguide layer other than the first waveguide layer 102 and the second waveguide layer 106). In some implementations, the third waveguide layer may serve as a core layer. In such an implementation, the third waveguide layer may guide light and, rather than operating primarily to provide light guidance, the first waveguide layer 102 and the second waveguide layer 106 may be used to modify polarization state of the light guided in the third waveguide layer. Alternatively, the third waveguide layer may serve as a cladding layer. In such an implementation, the third waveguide layer may surround other layers of the PSR 100 in order to, for example, help confine light more effectively and reduce interaction with an external environment of the PSR 100.

In some implementations, a segmented waveguide structure described herein (e.g., a segmented waveguide 104 or a segmented waveguide 108) may be modeled using the effective medium theory (EMT) as follows:

$${ε}_{∥}^{=} {ε}_{∥}^{( 0 )} [ 1 + \frac{{π}^{2}}{3} {{ρ}^{2} ( 1 - ρ )}^{2} \frac{{( {ε}_{1} - {ε}_{2} )}^{2}}{{ε}_{∥}^{( 0 )}} {( \frac{Λ}{λ} )}^{2} ] \qquad ( 1 a )$$

$${ε}_{⊥}^{=} {ε}_{⊥}^{( 0 )} [ 1 + \frac{{π}^{2}}{3} {{ρ}^{2} ( 1 - ρ )}^{2} {( \frac{{ε}_{1} - {ε}_{2}}{{ε}_{1} {ε}_{2}} )}^{2} {( {ε}_{⊥}^{( 0 )} )}^{2} {{ε}_{∥}^{( 0 )} ( \frac{Λ}{λ} )}^{2} ] \qquad ( 1 b )$$

$$where$$

$${ε}_{∥}^{( 0 )} = ρ {ε}_{1} + ( 1 - ρ ) {ε}_{2} , and$$

$$\frac{1}{{ε}_{⊥}^{( 0 )}} = \frac{ρ}{{ε}_{1}} + \frac{1 - ρ}{{ε}_{2}}$$

Here, ρ represents the filling fraction of the material (e.g., ρ_{SiN} or ρ_{Si}i), Λ represents the periodicity along the direction of propagation (e.g., Λ_{SiN} or Λ_{Si}), ε₁ refers to a dielectric constant of the core material (e.g., ε_{SiN} in the case of a SiNₓ-based segmented waveguide 108 or ε_{Si} in the case of an Si-based segmented waveguide 104), and ε₂ refers to a dielectric constant of the cladding 110 (e.g., ε_{SiO2} in the case of a silica cladding 110). Notably, the above equations simplify the segmented/metamaterials structures by homogenizing them.

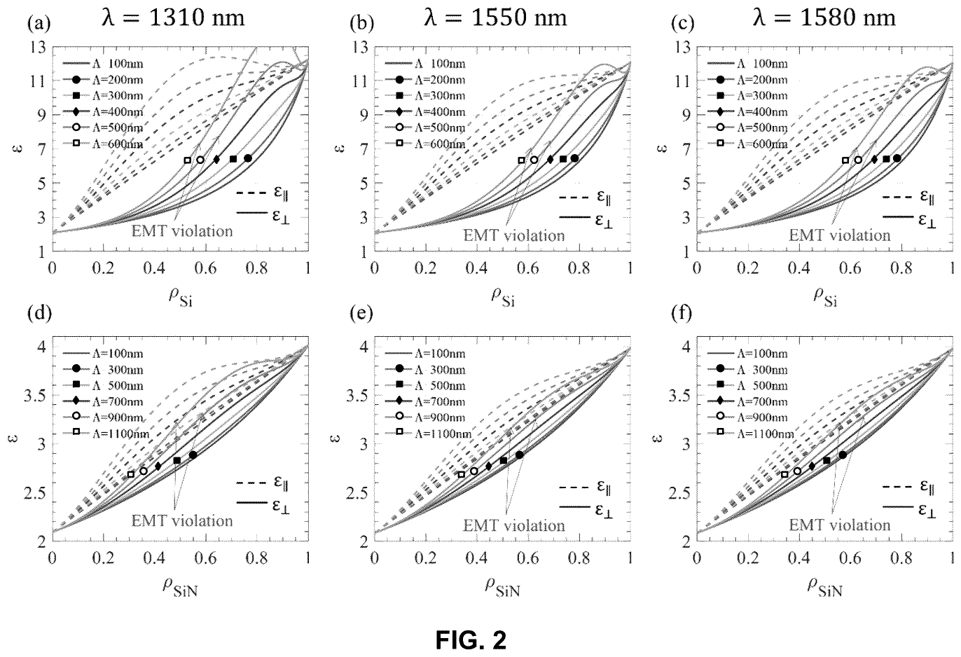

Equations 1a and 1b can be used to calculate a dielectric permittivity or dielectric constant of the homogenized medium, namely an artificial medium representing segmented waveguides (e.g., the segmented waveguides 104 and/or the segmented waveguides 108) with permittivity that varies depending on direction. Thus, characteristics of the segmented waveguides 104 and/or the segmented waveguides 108 needed to maintain effective medium properties at different wavelengths can be determined using Equations 1a and 1b. FIG. 2 illustrates examples of calculated dielectric constants ε with respect to filling fraction ρ for various wavelengths λ. In particular, FIGS. 2(a)-(c) and FIGS. 2(d)-(f) show examples of calculated ε_{∥} and ε_{⊥} permittivity for an Si-based segmented waveguide 104 and an SiNₓ-based segmented waveguide 108, respectively. As illustrated in FIG. 2, to maintain the effective medium properties, the operating wavelength λ should be significantly larger than periodicity Λ. Therefore, in FIGS. 2(a)-(c), Λ_{Si} may be less than approximately 400 nm (e.g., to enable operation in the O band), and less than approximately 500 nm (e.g., to enable operation in the C+L bands). Similarly, in FIGS. 2(d)-(f), Λ_{SiN} may be less than approximately 700 nm (e.g., to enable operation in the O band) and may be less than approximately 900 nm (e.g., to enable operation in the C+L bands). The arrows in FIG. 2 show the EMT violation when Λ_{Si} and Λ_{SiN} are comparable with the operating wavelength λ. With respect to FIG. 2, an EMT violation refers to a scenario in which the EMT no longer applies, namely when the EMT based on which the homogenized medium is designed is no longer valid. An EMT violation can occur if, for example, a periodicity or feature size (e.g., Λ_{Si}, Λ_{SiN}, or the like) of a segmented waveguide (e.g., a segmented waveguide 104 or a segmented waveguide 108) is comparable to or larger than a wavelength of incident light such that diffraction effects become significant. For example, such an EMT violation occurs when a ratio Λ/λ approaches or exceeds 1/n, where Λ is a periodicity of the segmented waveguide, λ is the wavelength of incident light, and n is the refractive index of the segmented waveguide. As indicated above, FIG. 2 is provided as an example. Other examples may differ from what is described with regard to FIG. 2.

As described above with respect to FIG. 1, in some implementations, the width of the waveguide 108a of the PSR may vary along the direction of propagation (e.g., w_{0,SiN}→w_{1,SiN}→w_{2,SiN}). Similarly, the width of a given waveguide 104 may transition along the direction of propagation (e.g., w_{1,Si}→w_{2,Si}→w_{1,Si}). In some implementations, width variations in the waveguide 108a and/or the waveguides 104 may facilitate a polarization mode rotation. With respect to operation of the PSR 100, a mode rotation trajectory can be divided into six sections—length L₀ through length L₅, where lengths L₁ to L₄ comprise the polarization rotation section (e.g., the polarization rotator of the PSR 100). Among these, the lengths L₀, L₁, and L₅ may be considered “relaxed” lengths, where the interaction with other modes is minimal. Conversely, the lengths L₂, L₃, and L₄ may need to be selected so as to ensure effective mode conversion.

In some implementations, the PSR 100 may include a double waveguide segment that includes two adiabatic segmented waveguide sections—a portion of the waveguide 108a in length L₆ and a portion of the waveguide 108b in length L₆. In some implementations, as shown in FIG. 1, these waveguide sections may be separated by a gap g along the length L₆. In some implementations, the gap g may enable the mode conversion from the waveguide 108a to the waveguide 108b with an adiabatic coupling. In some implementations, a section of the PSR 100 along the length L₆ may be referred to as mode splitter, as noted above. In some implementations, the bends in the waveguide 108a and the waveguide 108b in the length L₇ (e.g., S-bends are shown in FIG. 1) may separate the two fundamental transverse electric (TE₀) modes propagating through the waveguides 108a and 108b. In some implementations, the waveguide 108b in the mode splitter of the PSR 100 may include a curved section (e.g., in the length L₅) to facilitate smooth field transition with minimal loss.

In some implementations, within the polarization rotator of the PSR 100, the waveguide 104a and the waveguide 104b may be positioned such that the waveguides 104a and 104b are substantially centered on bounding edges of the waveguide 108a (e.g., as shown in FIG. 1 in a region along lengths L₂ and L₃). Further, in some implementations, the waveguide 104a and the waveguide 104b may be positioned such that ends of the waveguide 104a and ends of the waveguide 104b are away from the waveguide 108a so that the waveguide 104a and the waveguide 104b are substantially not beneath the waveguide 108a (e.g., as shown in FIG. 1 in a region along the length L₁ and a region along the length L₅).

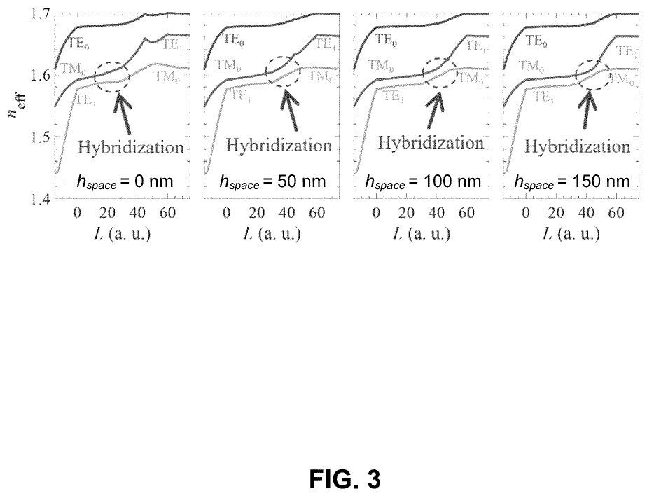

In some implementations, the PSR 100 provides polarization or mode rotation in segments L₁ to L₄ followed by mode splitting in segment L₆, and separation in L₇. FIG. 3 is a diagram illustrating effective indices of the TE₀ mode, the TM₀ mode, and the TE₁ mode for the PSR 100 with different spacer region heights h_{space}. In some implementations, the rotation section of the PSR 100 facilitates the rotation of the TM₀ mode to the TE₁ mode, while retaining the TE₀ mode intact. FIG. 3 shows the effective indices of the TE₀, TM₀, and TE₁ modes for values of h_{space} of 0 nm, 50 nm, 100 nm, and 150 nm. As can be seen in FIG. 3, there is a strong hybridization between the TM₀ mode and the TE₁ mode (indicated with dashed circles). This is due to the segmented waveguides 104 (e.g., Si-based segmented waveguides 104), which excites the TE₁ mode, hence enhancing the perturbation to couple with the TM₀ mode, thus causing hybridization. In FIG. 3, with different values of the height h_{space}, the TM₀ mode follows the path to become the TE₁ mode along an arbitrary length L. With a height h_{space} of 0 nm (i.e., when the second waveguide layer 106 is on the first waveguide layer 102), there are sharp peaks in the effective index n_{eff} for the TE₀ mode and the TM₀→TE₁ modes, which is due to the power leakage to the segmented waveguides 104, thereby introducing high photon absorption when input power is high. With a larger offset (e.g., a height h_{space} of at least 50 nm), such leakage to the waveguides 104 is not present, but enhanced perturbation (meaning hybridization) occurs, which is suitable for a high-power PSR 100 since power remains within the segmented waveguide 108 and the PSR 100 has a very low nonlinearity, which reduces the nonlinear power loss. Note that with a height h_{space} of 0 nm, the filling fraction ρ_{Si} may need to be selected so as to ensure no leakage to the segmented waveguides 104, while keeping the condition 0.1<ρ_{Si}<0.5. Therefore, the thickness of the cladding 110 between the first waveguide layer 102 and the second waveguide layer 106 (e.g., the height h_{space} of the cladding 110 between the waveguides 104 and the waveguides 108) may need to be designed for a particular psi in order to reduce or minimize the nonlinear absorption loss while ensuring large perturbation to facilitate hybridization. As indicated above, FIG. 3 is provided as an example. Other examples may differ from what is described with regard to FIG. 3.

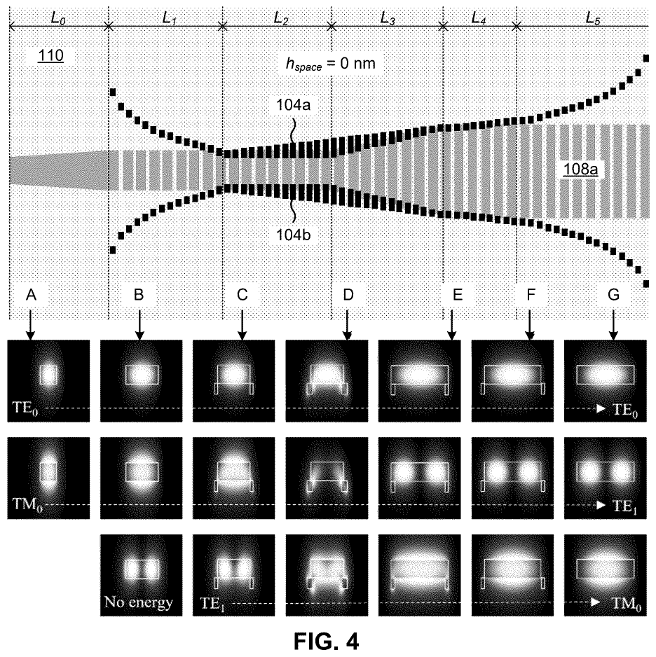

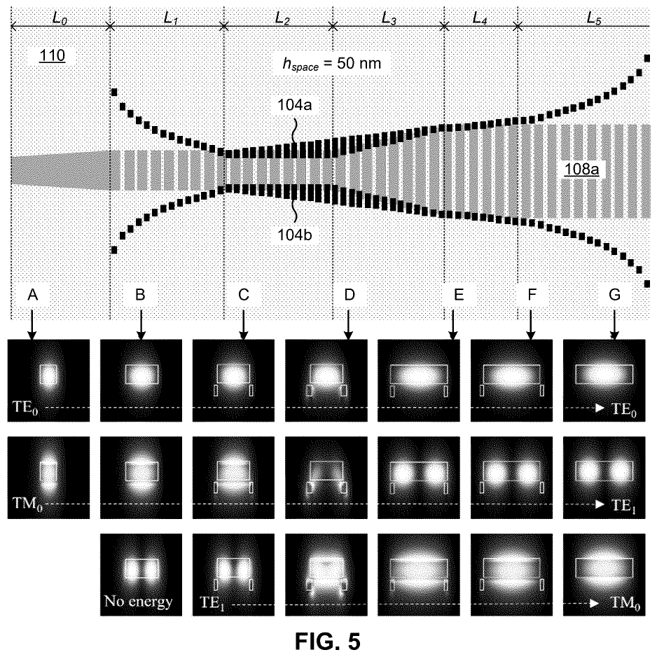

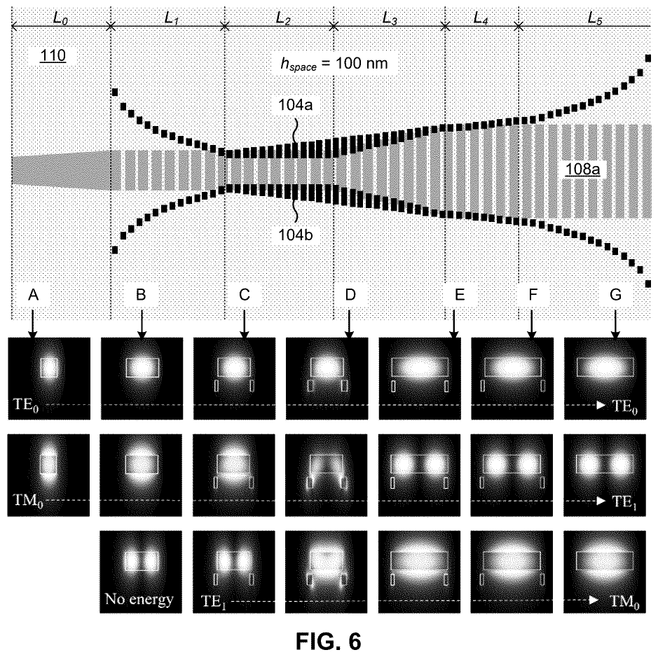

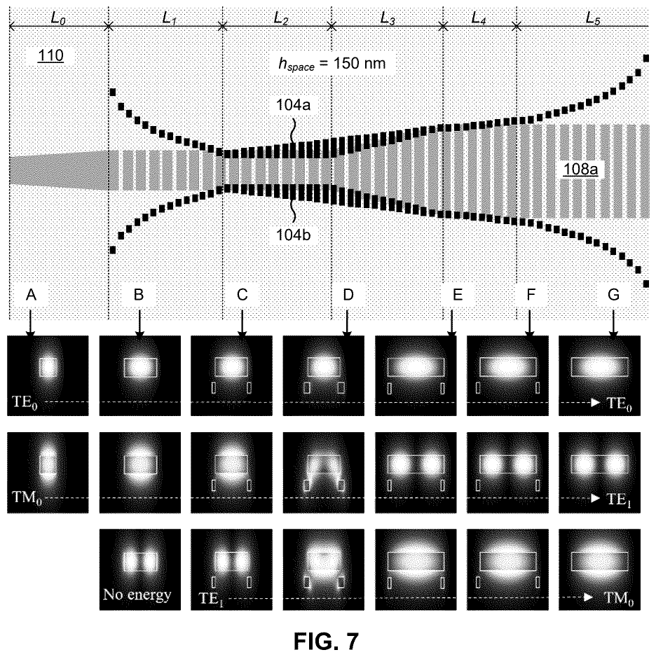

FIGS. 4-7 are diagrams illustrating field profiles determined by the effective indices as shown in FIG. 3 to illustrate the behavior of different modes within the polarization rotator of the PSR 100. FIGS. 4-7 illustrate how power of the distribution modes changes as the height h_{space} varies from 0 nm to 150 nm in increments of 50 nm. In FIG. 4, which corresponds to a PSR 100 in which h_{space} is 0 nm scenario, the power of the TE₀ and TM₀ modes is significantly coupled into the segmented waveguides 104, specifically at the location marked D. This coupling indicates higher leakage and potential nonlinear losses within the segmented waveguides 104. FIG. 5 illustrates field profiles for a PSR 100 with a height h_{space} of 50 nm. In FIGS. 6 and 7, which illustrate field profiles for PSRs 100 with a height h_{space} of 100 nm and 150 nm, respectively. In these scenarios, the power of the TE₀ and TM₀ modes predominantly remains within the segmented waveguide 108, notably at the same location D, which indicates a reduction in nonlinear power loss (e.g., less nonlinearity in SiNₓ), which is desirable for maintaining PSR efficiency, particularly under high-power conditions. Throughout the height h_{space} variations shown in FIGS. 4-7, the TM₀ mode undergoes hybridization with the TE₁ mode. This hybridization is caused by the perturbations introduced by the segmented waveguides 104 and can be seen in the field profiles. As a result, the TM₀ mode transforms into the TE₁ mode by the end of the rotation length (e.g., by an end of the length L₄). As indicated above, FIGS. 4-7 are provided as examples. Other examples may differ from what is described with regard to FIGS. 4-7.

In some implementations, to achieve efficient mode conversion along the rotation length of the PSR 100, the values of a set of parameters (e.g., the length L₀, the length L₁, the length L₂, the length L₃, the length L₄, the length L₅, the width w_{0,SiN}, the width w_{1,SiN}, the width w_{2,SiN}, the width w_{1,Si}, or the width w_{2,Si}) need to be appropriately selected. In the description below, various height h_{space} values (e.g., h_{space}=0 nm to 150 nm) are used, and fine-tuning of the parameters the length L₂, the length L₃, and the length L₄ is performed. Note that prior to optimizing these lengths, optimization of one or more parameters of the waveguides 104 (e.g., the width w_{1,Si}, the width w_{2,Si}, the filling fraction ρ_{Si}, the periodicity Λ_{Si}, or the like) and/or one or more parameters of the waveguide 108a (e.g., the width w_{0,SiN}, the width w_{1,SiN}, the width w_{2,SiN}, the filling fraction ρ_{Si}, the periodicity Λ_{SiN}, or the like) may be needed in order to facilitate substantial hybridization as described above.

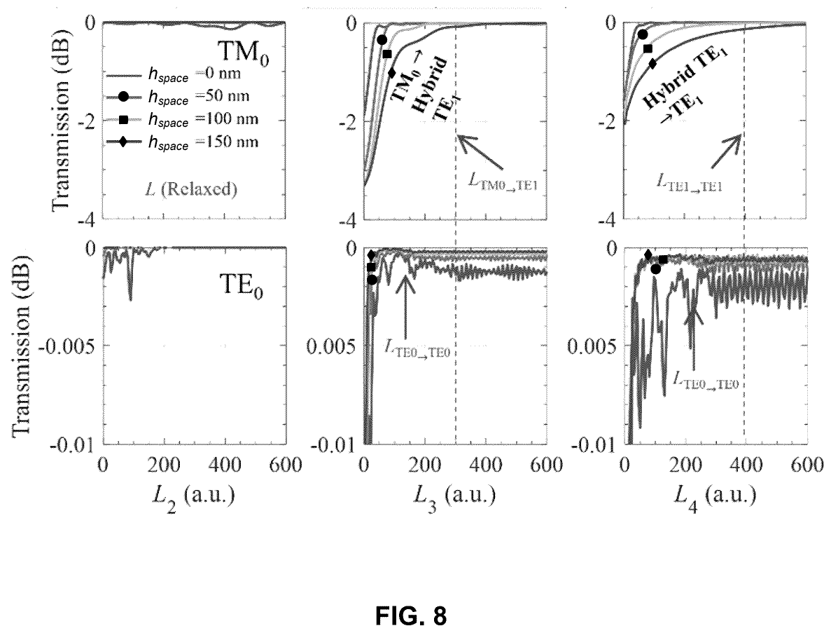

FIG. 8 illustrates eigenmode expansion for the excitation of the TE₀ and TM₀ fundamental modes. In some implementations, the lengths L₀, L₁, and L₅ may have relaxed constraints due to minimal interference with other modes. In some implementations, to ensure a smooth transition of mode field profiles, curved segment waveguides may be introduced in the lengths L₁ and L₅, as shown in FIG. 1. In operation, the TM₀ and TE₀ modes are excited from the input taper along the length L₀, followed by eigenmode expansion along the lengths L₂, L₃, and L₄ with varying values of height h_{space} (e.g., different SiO₂ thicknesses) and keeping the lengths L₁ and L₅ relaxed. Mode expansion along the length L₂ does not significantly affect transmission or cause mode interference when the TM₀ mode is excited, as shown in the upper diagrams of FIG. 8, thereby enabling relaxation of the length L₂. However, the lengths L₃ and L₄ are important with respect to conversion between the TM₀→hybrid TE₁ and hybrid TE₁→TE₁ modes. Thus, the length L₃+L₄ may be selected as the optimal conversion length for achieving overall TM₀→TE₁ mode conversion. Conversely, with a TE₀ input, as shown in the lower diagrams of FIG. 8, there is no interference with other modes due to high index contrast and the TE₀ mode transmits without notable loss throughout the lengths L₂, L₃, and L₄. Note that different lines in the diagrams shown in FIG. 8 present different values of the height h_{space} (e.g., 0 nm, 50 nm, 100 nm, and 150 nm. As indicated above, FIG. 8 is provided as an example. Other examples may differ from what is described with regard to FIG. 8.

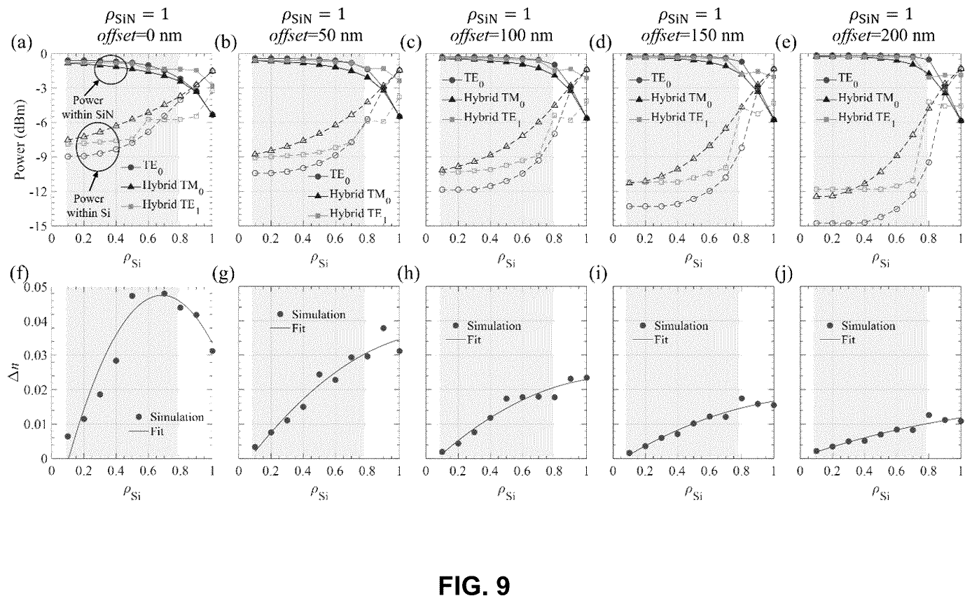

Simulations can be used to determine how different parameters, such as the filling fraction ρ_{Si}, the filling fraction ρ_{SiN} and the gap g, affect the hybridization of modes within the PSR 100. FIG. 9 shows the effect of the filling fraction ρ_{Si} on power confinement in the waveguides 104 and the waveguide 108a as the height h_{space} is varied. For example, in FIG. 9(a), power confinements for the TE₀, hybrid TM₀, and hybrid TE₁ modes are shown with a height h_{space} of 0 nm. The dashed lines with markers show the power confinement in the waveguides 104, while solid line markers show the power confinement in the waveguide 108a. Note that with higher filling fraction ρ_{Si}, power leaks to the waveguides 104 due to the higher index. By controlling the filling fraction ρ_{Si}, the maximum power within the segmented waveguide 108a can be controlled. FIGS. 9(f)-(j) illustrate the coupling coefficient factor Δn for the same condition as in FIGS. 9(a)-(e). The dots and solid lines present the simulation and fit data, respectively. As shown, as the height h_{space} increases from 0 nm to 200 nm, as shown in FIGS. 9(a)-(e), the power within the waveguide 108a increases, which reduces the leaks to the waveguides 104. However, this also leads to a reduction in the hybridization of the TM₀ and TE₁ modes, as shown in FIGS. 9(f)-(j). Due to this trade-off, an optimized height h_{space} should be selected so as to ensure maximum power within the waveguide 108a as well as significant hybridization. Notably, even with a large offset (e.g., 200 nm), a large filling fraction ρ_{Si} cannot be used. The filling fraction ρ_{Si} may in some implementations be limited to a range between approximately 0.1 to approximately 0.8, as indicated by the shaded areas in FIGS. 9(a)-(j), to achieve enhanced hybridization and maximum power coupling within the waveguide 108a. As indicated above, FIG. 9 is provided as an example. Other examples may differ from what is described with regard to FIG. 9.

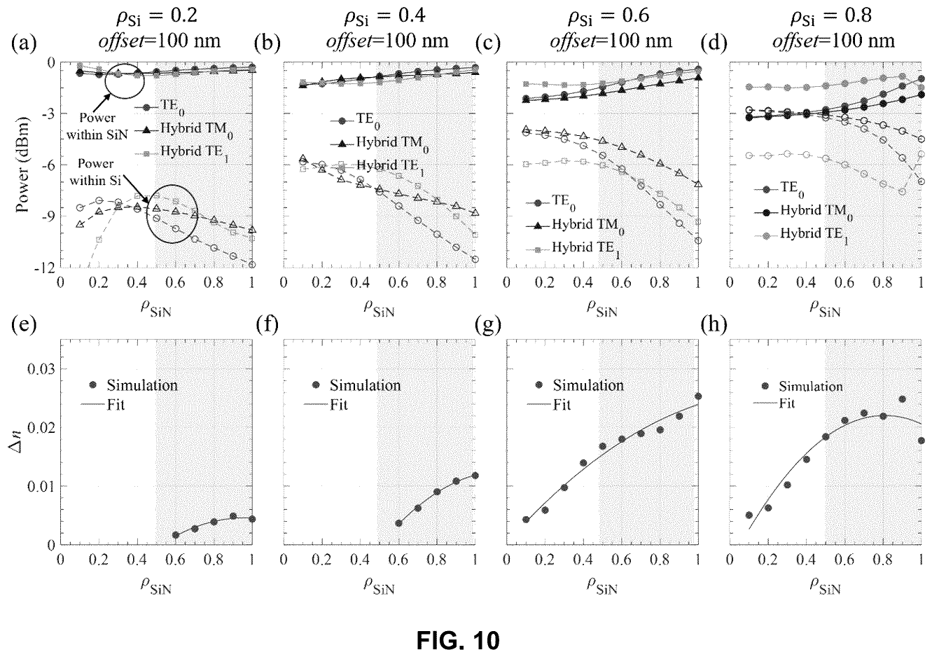

FIG. 10 shows the effect of the filling fraction ρ_{SiN} on power confinement in the waveguides 104 and the waveguide 108a for a height h_{space} of 100 nm with variation of the is filling fraction ρ_{Si}. FIGS. 10 (a)-(d) show the power confinements in the waveguides 104 and the waveguide 108, and FIGS. 10(e)-(h) show the coupling factor Δn while varying ρ_{SiN}−ρ_{Si}=0.2 in FIGS. 10(a) and (e), ρ_{Si}=0.4 in FIGS. 10(b) and (f), ρ_{Si}=0.6 in FIGS. 10(c) and (g), and ρ_{Si}=0.8 in FIGS. 10(d) and (h). The dashed and solid line markers, depicted in FIGS. 10(a)-(d), show the power confinement in the waveguides 104 and the waveguide 108a, respectively. As shown, with a smaller filling fraction ρ_{Si} (e.g., ρ_{Si}=0.2), most of the power remains within waveguide 108. However, there is low hybridization when the filling fraction ρ_{SiN} is between approximately 0.5 and 1.0, and hybridization when the filling fraction ρ_{SiN} is less than 0.5, as shown in FIG. 10(e). With the incrementing of the filling fraction ρ_{Si}, the hybridization increases, as shown in FIGS. 10(e)-(h), but power in the waveguides 104 also increases, as shown in FIGS. 10(a)-(d). Due to this trade-off, the filling fraction ρ_{SiN} may in some implementations be designed for a specific filling fraction ρ_{Si} and height h_{space}. The shaded areas in FIGS. 10(a)-(h) show the filling fraction ρ_{SiN} needed to achieve the desired hybridization and maintain most of the power within the waveguide 108a. As indicated above, FIG. 10 is provided as an example. Other examples may differ from what is described with regard to FIG. 10.

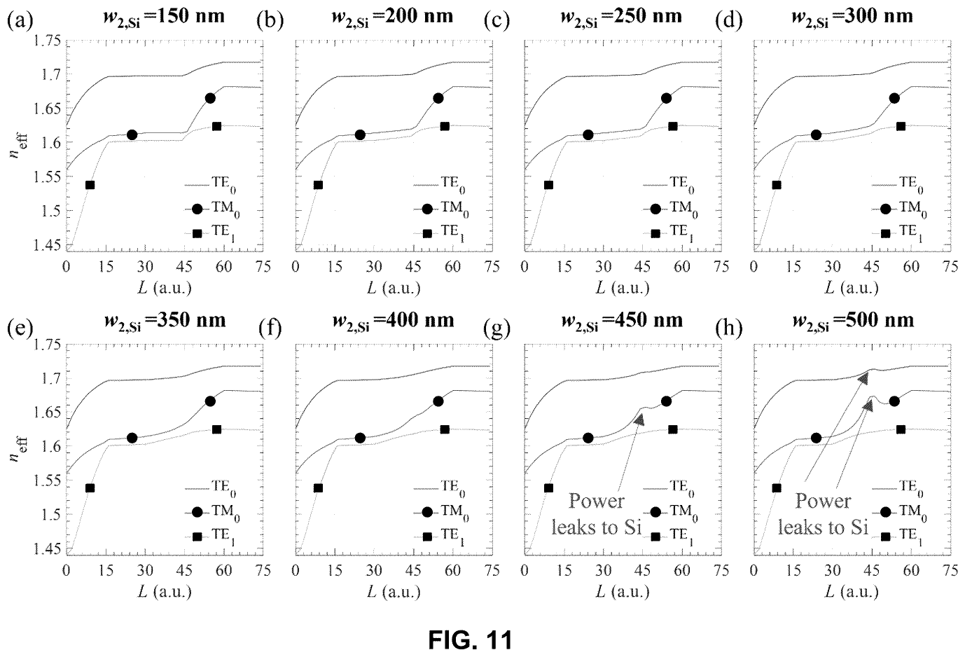

FIG. 11 illustrates effective indices n_{eff} along the rotation section of the PSR 100 for different values of the width w_{2,Si}. Note, in the example associated with FIG. 11, the width w_{1,Si} is 150 nm, the height h_{space} is 100 nm, the filling fraction ρ_{Si} is 0.5, and the filling fraction ρ_{SiN} is 1.0. As shown in FIGS. 11(a)-(h), with the incrementing of the width w_{2,Si}, there is a strong mode hybridization, making the coupling factor Δn large. However, with the width w_{2,Si} being equal to or greater than approximately 450 nm, the mode power leaks to waveguides 104. The arrows show such power leaks in FIGS. 11(g)-(h), which may limit the use of such large widths w_{2,Si}. Thus, in some implementations, for a filling fraction ρ_{Si} in a range from approximately 0.1 to approximately 0.8, the width w_{2,Si} may be less than approximately 450 nm. As indicated above, FIG. 11 is provided as an example. Other examples may differ from what is described with regard to FIG. 11.

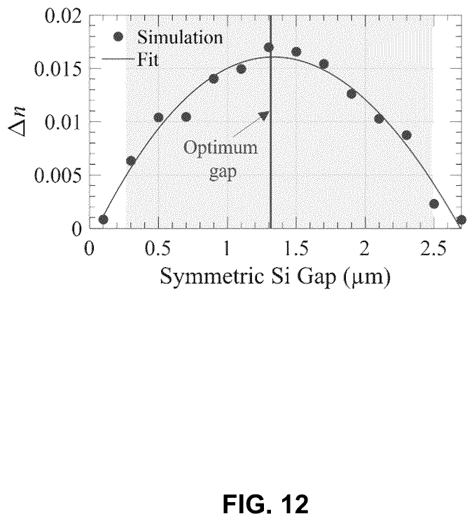

An analysis of the impact of spacing in the x-direction between the waveguides 104 (e.g., within the length L₂ as shown in FIG. 1) on hybridization was also performed. In this analysis, the filling fraction ρ_{Si} is 0.5, the filling fraction ρ_{SiN} is 1.0, and the height h_{space} is 100 nm. FIG. 12 is a diagram illustrating a coupling factor Δn, while the spacing between the waveguides 104 is varied. Note, as illustrated in FIG. 12, that with a spacing of approximately 1.3 μm, maximum hybridization and a shorter conversion length are achieved. The shaded area (e.g., a spacing of greater than or equal to approximately 0.3 μm and less than or equal to approximately 2.5 μm) indicates the spacing needed between the waveguides 104 needed to achieve some level of hybridization. As indicated above, FIG. 12 is provided as an example. Other examples may differ from what is described with regard to FIG. 12.

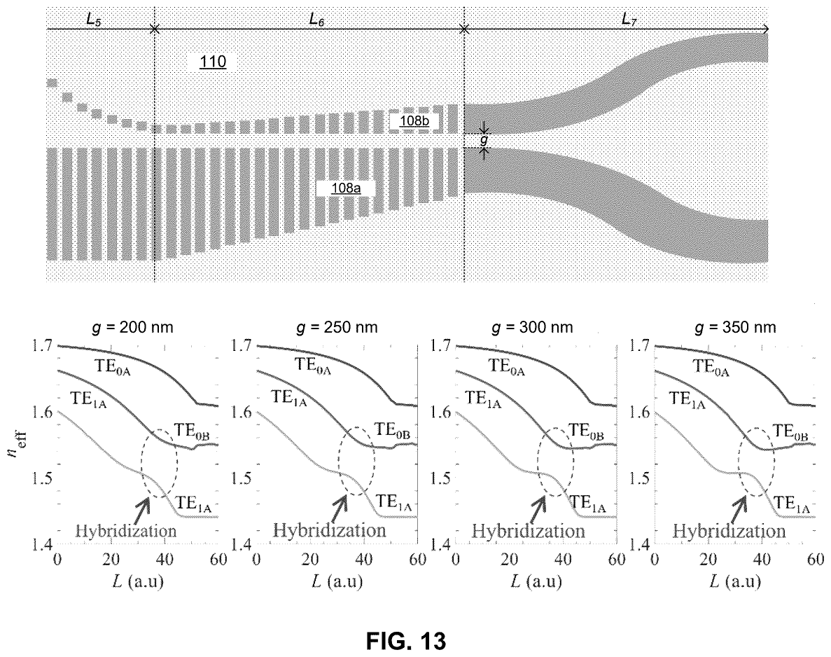

In some implementations, the mode splitter of the PSR 100 may be provided within the lengths L₆ (and the length L₇) as described above. In some implementations, the mode splitter may operate to split the TE₁ mode, which is rotated from the TM₀ input in the rotation section of the PSR 100. In some implementations, the waveguide 108b is provided to split the TE₁ mode. In some implementations, the waveguide 108b is an adiabatic waveguide. In some implementations, a width of the waveguide 108b may change such that the waveguide 108 comprises a tapered section. For example, in one implementation, the waveguide 108b may taper from the width w_{4,SiN} (e.g., approximately 300 nm) to the width w_{5,SiN} of 700 nm along the length L₆ as the waveguide 108a tapers down from the width w_{2,SiN} (e.g., 3500 nm) to the width w_{3,SiN} (e.g., 1000 nm) along the length L₆. In some implementations, the waveguide 108b may comprise a curved section to reduce scattering loss and facilitate a smooth modal transition of TE₁ mode from the waveguide 108a to the TE₀ mode at the waveguide 108b, while keeping the TE₀ mode of the 108a at the waveguide 108a. FIG. 13 illustrates an example of effective indices n_{eff} of different modes supported by the waveguide 108a and the waveguide 108b along the mode splitter of the PSR 100. Each diagram in FIG. 13 represents a value of the gap g (e.g., in a range from 200 nm to 350 nm). TE_{0A}, TE_{1A}→TE_{0B}, and TE_{0B}→TE_{1A} denote supported fundamental and first order modes along the length of the mode splitter. The modes of the waveguide 108a and the waveguide 108b are denoted by subscripts A and B, respectively. Dashed circles indicate a strong hybridization region between the TE_{1A} and TE_{0B} modes, resulting in a short TE_{1A}→TE_{0B} conversion length as described below. Note that the TE₁ mode of the waveguide 108a follows the paths, as shown in FIG. 13, and becomes the TE₀ mode at the waveguide 108b. Here, the size of the gap g does not significantly affect the hybridization (Δn=|n_{TE1A}−n_{TE0B}|), which provides robust tolerance with respect to the size of the gap g. In some implementations, the adiabatic coupler of the mode splitter of the PSR 100 is followed (e.g., in the separator section) by two S-bends to separate the TE_{0A} mode (in the waveguide 108a) and the TE_{0B} mode (in the waveguide 108b) within the length L₇. As indicated above, FIG. 13 is provided as an example. Other examples may differ from what is described with regard to FIG. 13.

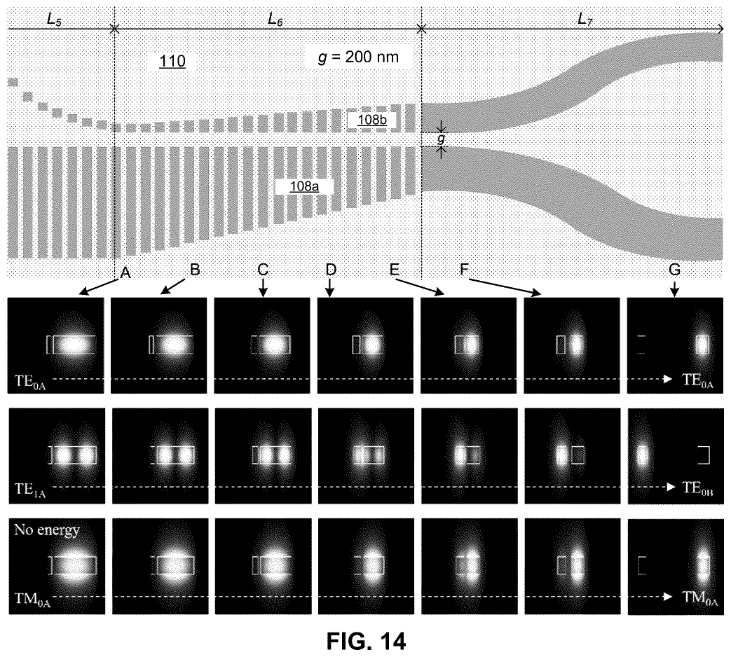

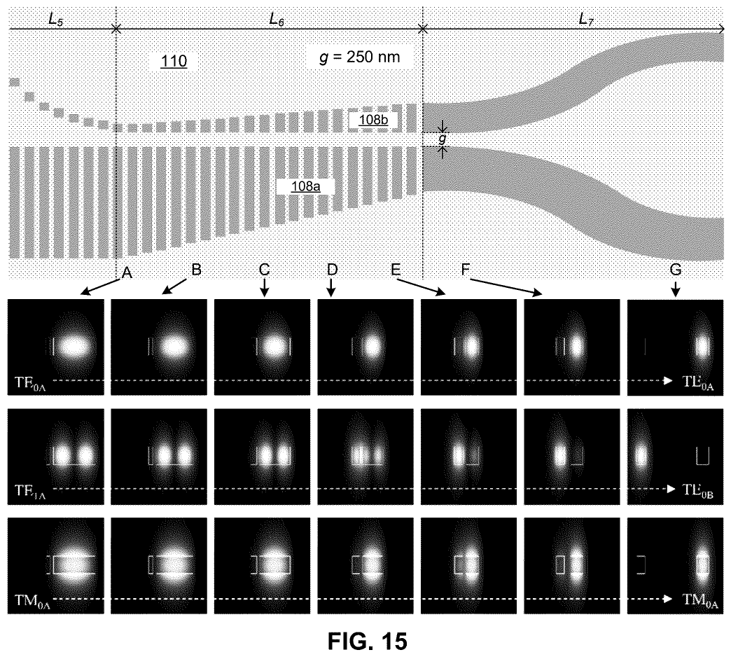

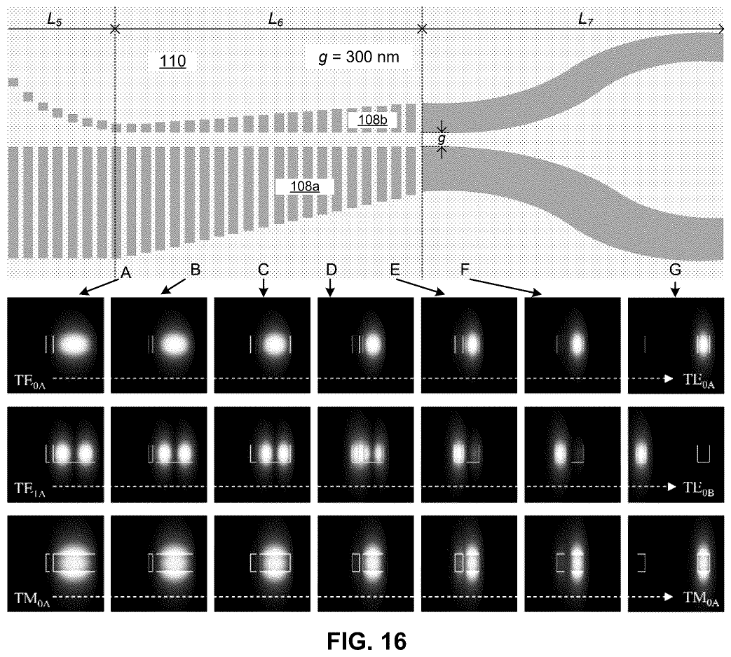

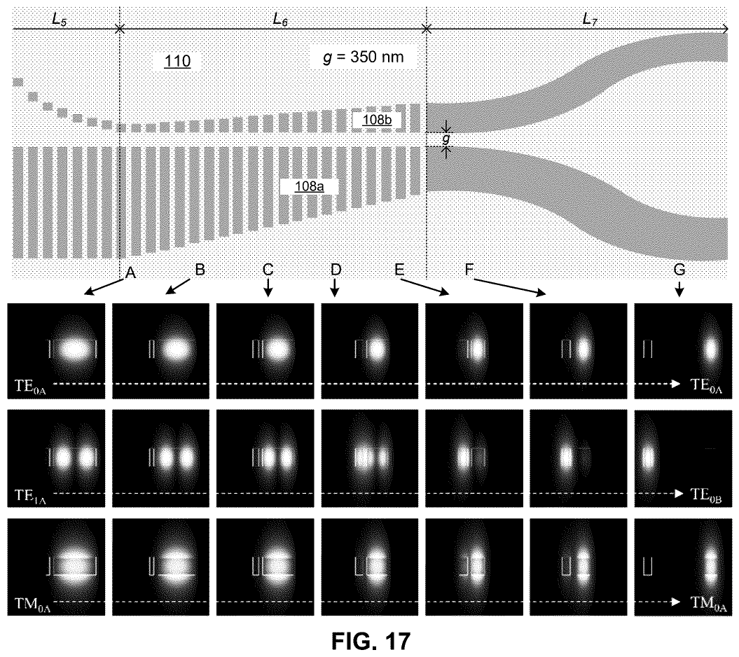

The effective indices n_{eff} shown in FIG. 13 are indicative of the field profiles, which demonstrate how the modes are distributed along the splitting length. The field profiles are shown in FIGS. 14-17. As indicated in FIGS. 14-17, each figure corresponds to a different gap g: g=200 nm in FIG. 14, g=250 nm in FIG. 15, g=300 in FIG. 16, and g=350 nm in FIG. 17. As can be seen from the field distributions shown in FIGS. 14-17, the TE_{0A} mode remains in the waveguide 108a without significant coupling or interference with other modes due to the large index contrast. However, the TE_{1A} mode of the waveguide 108a gradually evolves along the length L₆ and becomes the TE_{0B} mode in the waveguide 108b, as shown in FIGS. 14 through 17, due to the strong hybridization and coupling. Thus, two TE₀ modes are provided at the end of the S-bends of the waveguide 108a and the waveguide 108b. Notably, except for the TE_{0A} mode and the TE_{1A} mode (i.e., rotated from the TM₀ mode), other modes (ideally) have no energy since these other modes are not excited from the input end of the PSR 100. As indicated above, FIGS. 14-17 are provided as examples. Other examples may differ from what is described with regard to FIGS. 14-17.

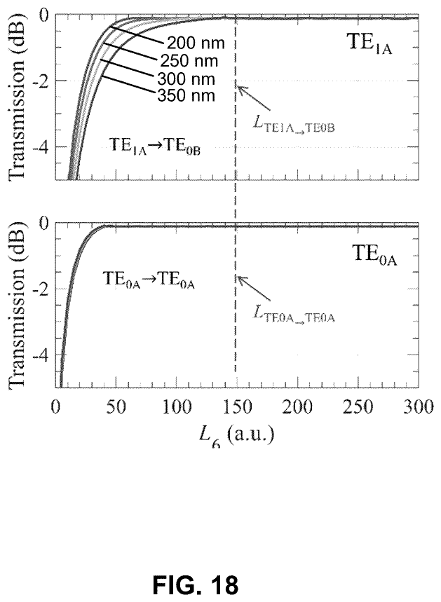

As illustrated in FIG. 13 described above, there may be a strong hybridization and coupling between the TE_{1A} and TE_{0B} modes in the PSR 100, which should result in a short splitting length. To calculate and verify this splitting/conversion length of TE_{1A}→TE_{0B}, the hybrid TE_{1A} mode was excited from an input end of the mode of the PSR 100 and an eigenmode expansion was performed. FIG. 18 is a diagram illustrating the corresponding mode conversion length. As shown in the upper diagram of FIG. 18, within L=L_{TE1A→TE0B}, power in the TE_{1A} mode is fully translated to power in the TE_{0B} mode (e.g., as also shown in FIGS. 14-17). Further, as shown in the lower diagram of FIG. 18, with TE_{0A} excitation and a length L of L_{TE0A→TE0A}, most of the power of the TE_{0A} mode remains within the waveguide 108a without any significant conversion or coupling (e.g., as also shown in FIGS. 14-17). Different lines in the diagrams shown in FIG. 18 represent different values of the gap g (e.g., 200 nm, 250 nm, 300 nm, and 350 nm). This further confirms the large tolerance of the PSR 100 with respect to variations in the gap g. As indicated above, FIG. 18 is provided as an example. Other examples may differ from what is described with regard to FIG. 18.

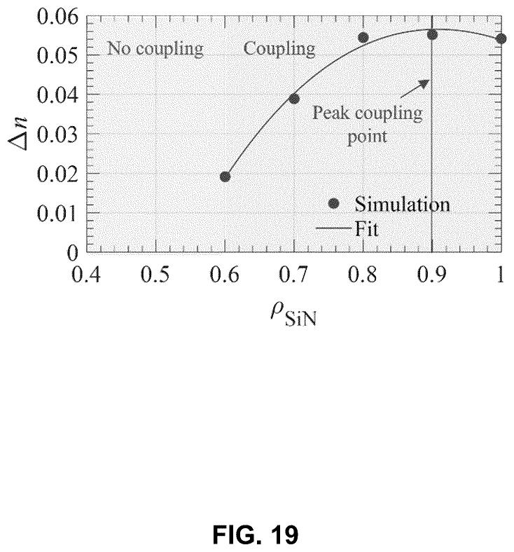

FIG. 19 is a diagram illustrating an example associated with a coupling factor Δn for different values of the filling fraction ρ_{SiN} with respect to the mode splitter of the PSR 100. The labeled areas, as shown in FIG. 19, represent coupling and no-coupling regions, respectively. As shown, for a filling fraction ρ_{SiN} that is less than approximately 0.6, no-coupling is observed (e.g., due to the low index in the narrower waveguide). Of note, the waveguide 108a and the waveguide 108b may in some implementations have the same filling fraction ρ_{SiN}. Therefore, an optimum filling fraction ρ_{SiN} (e.g., approximately 0.9) may be needed in order to achieve a larger coupling factor Δn (conversely, a shorter length L₆). As indicated above, FIG. 19 is provided as an example. Other examples may differ from what is described with regard to FIG. 19.

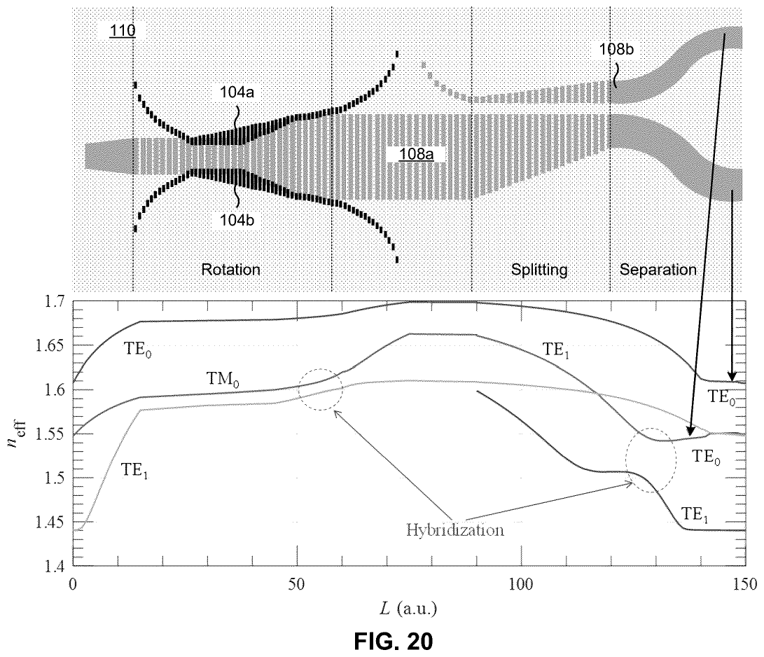

FIG. 20 illustrates effective indices n_{eff} of the fundamental and first-order modes throughout the length of the PSR 100. The top diagram of FIG. 20 identifies the rotation section (e.g., the polarization rotator) of the PSR 100, the splitting section (e.g., the mode splitter) of the PSR 100, and the separation section (e.g., the separator of the PSR 100). The effective indices n_{eff} of the fundamental and first-order modes throughout the length of the PSR 100 are shown in the lower diagram of FIG. 20. As shown, the index of the TE₀ mode increases as the width of the waveguide 108a increases, and becomes larger where the waveguides 104a and 104b have a larger width. The output is a TE₀ mode in the waveguide 108a without any coupling or conversion due to a large index contrast with other modes. On the other hand, in the rotation segment, the TM₀ input first couples and hybridizes with the TE₁ mode (in waveguide 108a) and then couples and hybridizes with the TE₀ mode (in waveguide 108b) and outputs at the waveguide 108b as a TE₀ mode. Power of the modes mostly remains within the waveguides 108a and 108b, which provides reduced optical and nonlinear losses for high power applications. As indicated above, FIG. 20 is provided as an example. Other examples may differ from what is described with regard to FIG. 20.

In this way, one or more parameters of the PSR 100 (e.g., the filling fraction ρ_{Si}, the filling fraction ρ_{SiN}, the periodicity Λ_{Si}, the periodicity Λ_{SiN}, or the like) may enable precise control over mode propagation, ensuring that a given mode remains confined within a desired waveguide (e.g., the waveguide 108a or the waveguide 108b). This confinement may significantly reduce nonlinear losses attributed to two-photon absorption. In some implementations, the PSR 100 described herein exhibits lower nonlinearity (e.g., as compared to conventional SiNₓ and/or Si waveguides), which further reduces nonlinear losses. Notably, the PSR 100 described herein can be used in a variety of applications, such as a high-power application, as power is effectively contained within the waveguide 108a and/or the waveguide 108b, which may comprise an inherently low-loss material (e.g., SiNₓ).

Notably, the PSR 100 described herein may be suitable for use across various bands, including the O, E, S, C, and L bands, with only a need to adjust parameters of the PSR 100 appropriately. Further, the PSR 100 described herein may be compatible with an Si platform or an SiNₓ platform, as described above, as well as other material platforms (with appropriate tuning of waveguide dimensions).

The foregoing disclosure provides illustration and description, but is not intended to be exhaustive or to limit the implementations to the precise forms disclosed. Modifications and variations may be made in light of the above disclosure or may be acquired from practice of the implementations. For example, the devices and behaviors described herein are based on reciprocal linear optical principles. However, the devices and behaviors described and claimed herein can be similarly applied for use in a reciprocal manner (e.g., light propagated through a PSR in an opposite direction to effect a polarization-multiplexing combiner). Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a waveguide or one or more waveguides) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A photonic integrated circuit (PIC) comprising a polarization rotator, the polarization rotator comprising:
a first waveguide layer comprising a first set of waveguides, wherein at least one waveguide of the first set of waveguides is a segmented waveguide; and
a second waveguide layer comprising a second set of waveguides,
wherein a refractive index of a core material of the second set of waveguides is less than a refractive index of a core material of the first set of waveguides.

2. The PIC of claim 1, wherein the first waveguide layer is a silicon (Si) waveguide layer and the second waveguide layer is a silicon nitride (SiNₓ) waveguide layer.

3. The PIC of claim 1, wherein the segmented waveguide has a periodicity that is less than approximately 500 nanometers.

4. The PIC of claim 1, wherein the segmented waveguide has a periodicity that is less than approximately λ/n, where λ is an operational wavelength of the polarization rotator and n is a refractive index of the segmented waveguide.

5. The PIC of claim 1, wherein a filling fraction associated with the first set of waveguides is in a range from approximately 0.1 to approximately 0.8.

6. The PIC of claim 1, wherein the first waveguide layer is on the second waveguide layer.

7. The PIC of claim 1, wherein the second waveguide layer is on the first waveguide layer.

8. The PIC of claim 1, wherein one or more waveguide segments of the segmented waveguide have a shape that is elongated with a longer dimension oriented at 90 degrees with respect to a direction of propagation.

9. The PIC of claim 1, wherein one or more waveguide segments of the segmented waveguide have a shape that is elongated with a longer dimension oriented at an arbitrary angle with respect to a direction of propagation.

10. The PIC of claim 1, wherein the polarization rotator includes a spacer region between the first waveguide layer and the second waveguide layer.

11. The PIC of claim 1, wherein the first set of waveguides comprises four curved waveguide sections with exponential tapering.

12. The PIC of claim 1, wherein at least one waveguide of the second set of waveguides comprises a segmented waveguide.

13. The PIC of claim 12, wherein the segmented waveguide has a periodicity that is less than approximately 900 nanometers.

14. The PIC of claim 12, wherein the segmented waveguide has a periodicity that is less than approximately λ/n, where λ is an operational wavelength of the polarization rotator and n is an effective refractive index of the polarization rotator.

15. The PIC of claim 1, wherein the first set of waveguides comprises a first waveguide and a second waveguide, the first waveguide and the second waveguide being arranged symmetrically with respect to a centerline of a waveguide in the second set of waveguides.

16. The PIC of claim 1, wherein the first set of waveguides comprises a first waveguide and a second waveguide, where a spacing between the first waveguide and the second waveguide is in a range from approximately 0.3 micrometers (μm) to approximately 2.5 μm along a taper length associated with the first waveguide and the second waveguide.

17. The PIC of claim 1, wherein a width of a waveguide in the first set of waveguides is less than approximately 450 nanometers.

18. The PIC of claim 1, wherein the PIC further comprises a mode splitter, where the polarization rotator is optically connected to the mode splitter.

19. The PIC of claim 18, wherein the mode splitter comprises one or more segmented waveguides.

20. The PIC of claim 18, wherein the mode splitter comprises a first tapered waveguide and a second tapered waveguide.

21. The PIC of claim 18, wherein the mode splitter comprises a curved waveguide with exponential tapering.

22. The PIC of claim 1, wherein one or more waveguide segments of the segmented waveguide are arranged along a direction that is substantially parallel to a direction of propagation.

23. The PIC of claim 1, wherein one or more waveguide segments of the segmented waveguide are arranged along a direction that is substantially perpendicular to the direction of propagation.

24. The PIC of claim 1, wherein the first set of waveguides and the second set of waveguides are surrounded by one or more of silica, an index matching fluid, or air.

25. The PIC of claim 1, wherein the polarization rotator further comprises a third waveguide layer, wherein the third waveguide layer serves as a core layer or a cladding layer.

26. The PIC of claim 1, wherein the segmented waveguide is positioned such that the segmented waveguide is substantially centered on a bounding edge of the a waveguide in the second set of waveguides.

27. The PIC of claim 1, wherein, the segmented waveguide is positioned such that ends of the segmented waveguide are away from and not beneath a waveguide in the second set of waveguides.

28. A photonic integrated circuit (PIC) comprising a polarization splitter-rotator, the polarization splitter-rotator comprising:
a polarization rotator including:
a first set of waveguides in a first waveguide layer, wherein at least one waveguide of the first set of waveguides is a segmented waveguide, and
a second set of waveguides in a second waveguide layer,
wherein a refractive index of a core material of the second set of waveguides is less than a refractive index of a core material of the first set of waveguides; and
a polarization splitter and a mode splitter, wherein the polarization splitter is optically connected to the mode splitter.

29. A photonic integrated circuit (PIC) comprising a polarization rotator, the polarization rotator comprising:
a silicon (Si) waveguide layer comprising a set of segmented Si waveguides,
wherein a periodicity of a segmented Si waveguide in the set of segmented Si waveguides less than approximately 900 nanometers (nm), and
wherein a filling fraction of the segmented Si waveguide is in a range from approximately 0.1 to approximately 0.8; and
a silicon nitride (SiNₓ) waveguide layer comprising a set of SiNₓ waveguides.
